(19) United States
(12) Patent Application Publication
(10) Pub. No.: US 2025/0236743 A1
(43) Pub. Date: Jul. 24, 2025

(54) COATINGS CONTAINING ZIRCONIUM SILICATE AND INORGANIC BINDERS FOR IMPACT RESISTANT THERMAL BARRIER APPLICATIONS

(71) Applicant: 3M INNOVATIVE PROPERTIES COMPANY, St. Paul, MN (US)

(72) Inventors: Matthew T. Johnson, Woodbury, MN (US); Dinh Ba Le, St. Paul, MN (US); Sebastian Goris, Inver Grove Heights, MN (US); Peter T. Dietz, Eagan, MN (US)

(21) Appl. No.: 18/703,462

(22) PCT Filed: Nov. 8, 2022
(86) PCT No.: PCT/IB2022/060751

§ 371 Date: Apr. 22, 2024

Related U.S. Application Data
(60) Provisional application No. 63/264,311, filed on Nov. 19, 2021.

(51) Int. Cl. C09D 7/61; C09D 1/02; C09D 7/40; H01M 50/164; H01M 50/449

(52) U.S. Cl. CPC C09D 7/61; C09D 1/02; C09D 7/70; H01M 50/164; H01M 50/449

(57) ABSTRACT

Coatings and articles containing the coatings that can be used as impact resistance thermal barriers in high temperature applications. The coatings comprise zirconium silicate and an inorganic binder comprising an alkali silicate or a sol. The coating may optionally comprise fibers. Articles containing the coatings can be made by mixing together the zirconium silicate, optionally the fibers, and either a solution of the alkali silicate or a sol to form a coating solution, applying the coating solution to at least the first major surface of a substrate, and hardening the coating solution by drying and curing the coating solution.

### BACKGROUND

An increasing demand for hybrid and fully electric vehicles is also leading to an increasing demand for safer, more efficient rechargeable batteries to fuel those electric vehicles. Such batteries, including the lithium-ion battery, are typically made up of several battery modules, and each battery module comprises many interconnected individual battery cells. When one cell in a battery module is damaged or faulty in its operation, the temperature within the cell may increase faster than heat can be removed. If the temperature increase remains unchecked, a catastrophic phenomenon called thermal runaway can occur resulting in a fire and blasts of particles as hot as 1000° C. or more. The resulting fire can spread very quickly to neighboring cells and subsequently to cells throughout the entire battery as a chain reaction. These fires can be potentially massive and can spread to surrounding structures and endanger occupants of the vehicle or structures in which these batteries are located.

### SUMMARY

One solution to reducing the potential for a catastrophic thermal runaway event is to use coatings to protect the components of a battery from the high temperatures and high velocity particles often associated with such events. In contrast to traditional thermal insulators (e.g., mica), coatings are relatively easy to apply, conform to the substrates on which they are applied, and take up minimal space within the article.

Inorganic thermal barrier coatings are currently being investigated for use in electric vehicles. These coatings typically comprise a silicate-based binder matrix loaded with various inorganic fillers. Most of these inorganic fillers contain multivalent cationic species (e.g., Ca²⁺ Al³⁺, Mg²⁺, or combinations thereof). However, these cations are also known silica “network formers” which, when mixed with an alkaline aqueous sodium silicate matrix, can cause a slurry to gel, thus decreasing the stability of the solution during storage and prior to application to a substrate.

The present disclosure describes the use of zircon (i.e., zirconium silicate) as an alternative inorganic filler. Despite the presence of the multivalent Zr⁴⁺ ion, it was found that coatings comprising zircon and an inorganic binder comprising an alkali silicate or a sol exhibited increased rheological stability, thus extending its shelf life for coating applications. Additionally, hardened coatings comprising the zircon and inorganic binder, and articles comprising such hardened coatings, exhibited high impact resistance (i.e., resistance to damage due to particle impact) and high thermal transfer resistance at elevated temperatures (e.g., up to 1800° C.). Such articles may be used, for example, as impact resistant thermal barriers in the construction of battery components to isolate fires and reduce the chance for a catastrophic thermal runaway.

In one embodiment, the present disclosure provides a coating comprising zirconium silicate, and an inorganic binder comprising an alkali silicate or a sol, wherein the sol comprises a colloidal solid in a liquid.

In another embodiment, the present disclosure provides an article comprising a substrate having a first major surface and a second major surface opposite the first major surface, and a hardened coating of the present disclosure on at least the first major surface of the substrate.

In a further embodiment, the present disclosure provides a method of making the article of the present disclosure, the method comprising mixing together the zirconium silicate and either a solution of the alkali silicate or a sol to form a coating solution, applying the coating solution to at least the first major surface of the substrate, and hardening the coating solution by drying and curing the coating solution.

In yet a further embodiment, the present disclosure provides a battery comprising a plurality of battery cells separated from one another by a gap, and the article of the present disclosure disposed in the gap between the battery cells.

In another embodiment, the present disclosure provides a battery comprising a compartment lid having an inner and outer major surface, the inner major surface covering a plurality of battery cells, and the article of the present disclosure disposed on the inner surface of the compartment lid.

As used herein:

The term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

In this application, terms such as “a,” “an,” and “the” are not intended to refer to only a singular entity, but include the general class of which a specific example may be used for illustration. The terms “a,” “an,” and “the” are used interchangeably with the phrases “at least one” and “one or more.” The phrases “at least one of” and “comprises at least one of” followed by a list refers to any one of the items in the list and any combination of two or more items in the list.

The term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

Reference throughout this specification to “some embodiments” means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful, and is not intended to exclude other embodiments from the scope of the disclosure.

The above summary of the present disclosure is not intended to describe each disclosed embodiment or every implementation of the present disclosure. The description that follows more particularly exemplifies illustrative embodiments.

### DETAILED DESCRIPTION

The following is an description of illustrative embodiments. It is to be understood that other embodiments may be utilized and structural changes may be made without departing from the scope of the present invention.

Coatings of the present application generally comprise zirconium silicate and an inorganic binder comprising an alkali silicate or a sol. In some embodiments, the coatings further comprise fibers. A coating is typically applied to one or more surfaces of a substrate and hardened by dehydration and curing. The resultant article can be used to create a high impact resistant thermal barrier that operates at temperatures as high as 1800° C. In some embodiments, the article can be used as a thermal barrier between cells in a battery, including cells in a battery module or a battery pack, to reduce the potential for catastrophic thermal runaway events. Additionally, or alternatively, the article can be used as a protective inner surface of a battery (e.g., inner surface of lid). Although the coatings and articles disclosed herein are discussed in the context of electric vehicle battery applications, it should be understood that the coatings and articles can be used in other applications desiring impact resistance and/or thermal transfer resistance at elevated temperatures.

The zirconium silicate used in the coating is not particularly limiting, and can be any of a number of stoichiometric mixtures of ZrO and SiO₂, including zirconium metasilicate, Zr(SiO₃)₂, and zirconium orthosilicate, ZrSiO₄. In some preferred embodiments, the coating comprises zirconium orthosilicate. Zirconium silicates generally contribute to the improved shelf life of the solution coating and the thermal stability and insulation performance of the hardened coating. In some embodiments, the coating comprises at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, at least 75 wt. %, at least 80 wt. %, at least 85 wt. %, at least 90 wt. %, or at least 95 wt. % zirconium silicate, based upon the percentage of solids in the coating. In some embodiments, the coating comprises up to 95 wt. %, up to 90 wt. %, up to 85 wt. %, up to 80 wt. %, up to 75 wt. %, up to 70 wt. %, up to 65 wt. %, up to 60 wt. %, up to 55 wt. %, or up to 50 wt. % zirconium silicate based upon the percentage of solids in the coating. In some embodiments, the coating comprises 20 wt. % to 95 wt. %, more particularly 40 wt. % to 95 wt. %, even more particularly 60 wt. % to 95 wt. % zirconium silicate based upon the percentage of solids in the coating. The term “solids”, as used herein in the context of percentage of solids in the coating, means the components that remain in the coating after dehydration and curing. Solvents (e.g., water) driven off during formation of the hardened coat are not considered solids. Since the solvent does not form part of the solids in the coating, the solids content will be approximately the same before and after a coating is dried and cured.

The inorganic binder that makes up the coating may comprise an alkali silicate. The term “silicate”, as used herein, means a salt in which the anion contains both silicon and oxygen. Silicates include metasilicates (SiO₃²⁻) and orthosilicate (SiO₄⁴⁻). Exemplary alkali silicates include sodium silicate, potassium silicate, lithium silicate, or combinations thereof. In some embodiments, the alkali silicate is a metasilicate having the formula M₂SiO₃, wherein M is Na, K or Li. In other embodiments, the alkali silicate is a polysilicate having the formula M₂O(SiO₂)ₓ·yH₂O, wherein M is selected from Li, Na, or K, x is between 1 and 15, preferably between 2 and 9, and y is >0. In some embodiments, the alkali silicate is sodium silicate or potassium silicate. In some further embodiments, the alkali silicate is Na₂SiO₃. The choice of silicate may depend upon the desired application. For example, adhesion between the coating and a substrate can be influenced by the nature of the alkali silicate, where adhesion decreases in order of sodium silicate, potassium silicate, and lithium silicate. Therefore, in some embodiments, sodium silicate may be the preferred alkali silicate. However, coatings made with potassium silicate tend to exhibit greater moisture resistivity and may be preferable in environments where the coating may be exposed to humidity. Therefore, in some embodiments, potassium silicate may be the preferred alkali silicate. In some embodiments, the coating comprises at least 5 wt. %, at least 10 wt. %, at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, or at least 70 wt. % alkali silicate based upon the percentage of solids in the coating. In some embodiments, the coating comprises up to 80 wt. %, up to 75 wt. %, up to 70 wt. %, up to 65 wt. %, up to 60 wt. %, up to 55 wt. %, up to 50 wt. %, up to 45 wt. %, or up to 40 wt. % alkali silicate based upon the percentage of solids in the coating. In some embodiments, the coating comprises 5 wt. % to 80 wt. %, more particularly 5 wt. % to 60 wt. %, even more particularly 5 or wt. % to 40 wt. % alkali silicate based upon the percentage of solids in the coating.

Alternatively, the inorganic binder that makes up the coating may comprise a sol. The term “sol”, as used herein, means a fluid suspension of a colloidal solid in a liquid. The colloidal solid can be macromolecules, oligomers, nanoparticles, or combinations thereof. Typically, the diameter of the colloidal solid ranges from 3 nm to 60 nm. The liquid is preferably water but may also include alcohols (e.g., ethanol and propanol). Sols of the present disclosure typically perform at high temperatures (e.g., above 1000° C.). Exemplary colloidal solids include silica (SiO₂), titania (TiO₂), alumina (Al₂O₃), Zirconia (ZrO₂), or combinations thereof. In some embodiments, the coating comprises at least 5 wt. %, at least 10 wt. %, at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, or at least 70 wt. % colloidal solids based upon the percentage of solids in the coating. In some embodiments, the coating comprises up to 80 wt. %, up to 75 wt. %, up to 70 wt. %, up to 65 wt. %, up to 60 wt. %, up to 55 wt. %, up to 50 wt. %, up to 45 wt. %, up to 40 wt. %, up to 35 wt. %, or up to 30 wt. % colloidal solids based upon the percentage of solids in the coating. In some embodiments, the coating comprises 5 wt. % to 80 wt. %, more particularly 5 wt. % to 60 wt. %, even more particularly 5 wt. % to 40 wt. % colloidal solids based upon the percentage of solids in the coating.

The coating of the present disclosure may optionally comprise fibers. Fibers can be used to enhance the mechanical properties of the coating, including increasing the blast or impact resistance of the coating and articles to which it has been applied. In some embodiments, where the coating is made with a sol, the fibers tend to reduce the formation of microscale cracks that can develop in the sol-based coatings during processing and/or use, which cracks tend to contribute to the weakening of the mechanical properties of the coating.

The fibers are typically made of high refractory glass or ceramic materials. A “refractory material” or “refractory”, as used herein, is a material that is resistant to decomposition by heat, pressure, or chemical attack, and retains strength and form at high temperatures. The fibers typically have an aspect ratio ranging from 50:1 to 500:1. Fibers having an aspect ratio less than 50:1 behave more like a powder and provide little-to-no performance benefit. Fibers having an aspect ratio greater than 500:1 typically have difficulty dispersing within the coating and can produce a rough (e.g., lumpy) surface coating. In some embodiments, the fibers have an average length ranging from 1/32 inch to ¼ inch.

Exemplary fibers include E-glass fibers, S-glass fibers, R-glass fibers, ECR-glass fibers, basalt fibers, ceramic fibers, aramid fibers, polycrystalline fibers, silicate fibers, alumina fibers, silica fibers, alumina-silica fibers, carbon fibers, silicon carbide fibers, boron silicate fibers, combinations thereof. The fibers may include annealed melt-formed ceramic fibers, sol-gel formed ceramic fibers, polycrystalline ceramic fibers, glass fibers, including annealed glass fibers or non-bio-persistent fibers. Suitable commercially available fibers include 3M™ Nextel™ fibers (e.g., 610 grade fibers available from 3M Company in St. Paul, MN), 1/32″ Milled Glass Fibers (available from FIBREGLAST® in Brookville, OH) and ⅛″ Chopped Glass Fibers (available under Product Code 01014 from PPG Industries in Pittsburgh, PA). While glass fibers typically have lower thermal conductivity than Nextel fibers, Nextel fibers are typically a higher refractory material. Therefore, in some preferred embodiments, the fiber is a Nextel™ fiber. In some embodiments, the coatings comprises at least 1 wt. %, at least 3 wt. %, at least 5 wt. %, at least 10 wt. %, at least 15 wt. %, at least 20 wt. %, or at least 25 wt. % fibers based on the percentage of solids in the coating. In some embodiments, the coating comprises up to 30 wt. %, up to 25 wt. %, up to 20 wt. % of the fibers based upon the percentage of solids in the coating. In some embodiments, the coating typically comprises 1 wt. % to 30 wt. % fibers based on the percentage of solids in the coating. Less than 1 wt. % and the fibers provide little-to-no performance benefit. Greater than 30 wt. % tends to inhibit the flowability of the coating and result in a lumpy (i.e. not smooth) coating.

Coatings of the present application may further include optional additives. Exemplary additives include defoamers, surfactants, rheological modifiers, forming aids, pH-adjusting materials, etc. Exemplary rheological modifiers can be organic compound, including natural or modified organic compounds selected from polysaccharides (e.g., xanthan, carrageenan, pectin, gellan, xanthan gum, diuthan, cellulose ethers such as carboxymethyl cellulose, methyl cellulose, ethyl cellulose and hydroxyethyl cellulose), proteins and polyvinyl alcohols. In some embodiments, the rheological modifier comprises fumed silica, fumed titania, fumed alumina, or combinations thereof. In some embodiments, the coating comprises 0 wt. %, at least 0.5 wt. %, at least 1 wt. %, at least 1.5 wt. %, at least 2 wt. %, at least 2.5 wt. %, at least 3 wt. %, at least 3.5 wt. %, at least 4 wt. %, at least 4.5 wt. %, or at least 5 wt. % additives based upon the percentage of solids in the coating. In some embodiments, the coating comprises up to 10 wt. %, up to 9 wt. %, up to 8 wt. %, up to 7 wt. %, up to 6 wt. %, up to 5 wt. %, up to 4 wt. %, or up to 3 wt. % additives based upon the percentage of solids in the coating. In some embodiments, the coating comprises 0 wt. % to 10 wt. %, more particularly 0.5 wt. % to 10 wt. %, even more particularly 0.5 wt. % to 5 wt. %, and further 1 wt. % to 3 wt. % additives based upon the percentage of solids in the coating.

The above coatings can be applied to a substrate to create articles exhibiting high impact and high thermal transfer resistance in high temperature applications. The substrates are typically flame resistant and may include flame resistant paper (e.g., inorganic paper or mica based paper), an inorganic fabric, or flame resistant boards (e.g., inorganic fiber boards or mica boards or sheets). Inorganic fabrics may comprise E-glass fibers, R-glass fibers, ECR-glass fibers, basalt fibers, ceramic fibers, silicate fibers, Nextel™ fibers, steel filaments, or combinations thereof. The fibers in the inorganic fabric may be chemically treated. The fabrics may, for example, be a woven or nonwoven mat, a felt, a cloth, a knitted fabric, a stitch bonded fabric, a crocheted fabric, an interlaced fabric, or combinations thereof. Substrates may also include flame resistant polymers, including thermoplastic resins, thermosetting resins, or glass-fiber reinforced resins (e.g., polyester). Substrates may further include metals or metal alloys, including aluminum, steel, or stainless steel. Substrates may comprise a single layer structure (e.g., sheets or foils) or a multi-layered structure comprising one or more of the forementioned materials. In embodiments where the coating comprises a sol, the substrate is preferably a porous substrate (e.g., fabric substrate) to insure adequate adhesion. Coatings comprising an alkali silicate as an inorganic binder tend to adhere more strongly to the substrate and can be used with porous or nonporous substrates.

In one method, the articles are made by mixing together the zirconium silicate and either a solution of the alkali silicate or a sol to form a coating solution, applying the coating solution to at least the first major surface of the substrate, and hardening the coating solution by drying and curing the coating solution. The term “hardened” as used in this context means that the coating has been dried (dehydrated) and cured to form an inorganic three-dimensional network. The coating layer can be applied by spraying, brushing, knife coating, nip coating, or dip coating, or the like in thicknesses of, for example, 0.1 mm to 15 mm. The coating solution is dried at a temperature of no more than 100° C. (by e.g., air-convective oven, infrared or microwave). The coating solution is cured at a temperature of at least 100° C.

The coating solution has a shelf life stability of at least 2 day, at least 5 days, at least 10 days, at least 15 days, or at least 20 days. Shelf life stability means the inorganic binder in the coating solution exhibits little to no gelation, such that the solution can be applied to a substrate by at least one of spraying, brushing, knife coating, nip coating, or dip coating. In some embodiments, the coating solution exhibits a viscosity, and the viscosity does not increase by more than 1%, 5%, or 10% over at least 2 days, at least 5 days, at least 10 days, or 20 days. In some preferred embodiments, the viscosity of the coating does not increase by more than 5% over at least 2 days, at least 5 days, at least 10 days, or at least 20 days, more particularly the viscosity of the coating does not increase by more than 1% over at least 2 days, at least 5 days, at least 10 days, or at least 20 days. In some embodiments, the viscosity of the coating does not increase over at least 2 days, at least 5 days, at least 10 days, or at least 20 days.

Articles of the present disclosure comprise a substrate and the hardened coating on at least one major surface. In some embodiments, the hardened coating encapsulates the entire substrate. The thickness of the coating will depend upon the desired application. For example, thinner coatings can be used for applications involving lower temperatures and/or lower potential particle blast forces. Thicker coatings would be used for higher temperature applications and/or higher potential particle blast forces. In some embodiments, the hardened coating has a thickness in the range of 0.1 mm to 6 mm.

Articles of the present application may be used in a variety of high impact, high temperature applications. For example, articles of the present disclosure may be used as impact resistant thermal barriers disposed in the gap between battery cells in an electric vehicle battery (e.g., in a battery module or a batter pack). In addition, or alternatively, the coatings or articles of the present disclosure may be disposed on the inner surface of the casing of a battery (e.g., a battery module or a battery pack), including the inner surface of a compartment lid or the inner surface of vent passages for exhaust gas. Further, the coatings and articles of the present disclosure may be used to protect a wide variety of components used in high voltage equipment, such as busbars used for high current power distribution.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims.

Unless otherwise noted or readily apparent from the context, all parts, percentages, ratios, etc. in the Examples and the rest of the specification are by weight. The following abbreviations are used throughout: wt. %=percent by weight; g=gram; μm=micrometer or micron; mm=millimeter; cm=centimeter; ° C.=degrees Celsius; and RPM=revolutions per minute.

TABLE 1
Materials Used in the Examples

| Abbreviation | Description and Source |
|---|---|
| Calcium | Calcium silicate powder, 5-microns average particle size, |
| Silicate | obtained from Vanderbilt Minerals, LLC, under trade |
| | designation VANSIL ® W-50. |
| Zirconium | Zirconium silicate powder, 5-microns average particle size, |
| Silicate | obtained from Trebol, LLC, under trade designation |
| | Ultrox ®. |
| Sodium | Nonstoichiometric sodium silicate solution (48.02 wt. % in |
| Silicate | water), SiO₂/Na₂O ratio of 2.8, obtained from PQ |
| | Corporation, Malvern, PA, under trade designation K |
| | SODIUM SILIATE. |
| Aluminum | 0.05-inches (1.27 mm) thick 6061 aluminum sheet (15.2 |
| Plate | cm × 15.2 cm), obtained from McMaster-Carr, Atlanta, |
| | GA. |

### Propane Torch Test Method

A sample panel prepared as described below in the Examples and the Comparative Examples was suspended inside a fume hood using a binder clip. The face of the sample was exposed to a propane flame from a standard propane torch (a hand torch cylinder Bernzomatic TX9, equipped with a classic brass torch Bernzomatic UL2317, available from Worthington Industries, Columbus, OH) with a torch-to-sample distance of approximately 1 inch (2.54 cm). The heated area was maintained in a localized spot approximately 1.5 inches (3.81 cm) from the outer edges of the square sample for the full duration of the test. Heating was maintained until the sample either substantially melted in the heated region or 10 minutes elapsed.

### Rheological Measurement Test Method

Slurry rheology was measured using a laboratory rheometer (a Brookfield DV-E, equipped with standard spindle #65Z, available from AMETEK Brookfield, Chandler, AZ). The sample in its mixing container was inserted into the rheometer and shear was applied by specifying the RPM of the spindle. Viscosity was recorded once steady state was achieved at shear rates corresponding to 5, 10, 20, 50, and 100 RPM.

### Comparative Example A (Comp Ex. A)

A coating solution was made by mixing 26.4 g of calcium silicate powder, 10.9 g of sodium silicate solution, and 13.5 g of deionized water. The mixing was done by high shear mixer (Speedmixer DAC 150.1 FVZ/Flack Tek Inc.).

The results of rheological measurements are summarized in Table 2. Measurement was possible at day 0; further measurement was not possible as a stiff gel had formed, and viscosity measurements were off scale.

### Comparative Example B (Comp Ex. B)

A coating solution was made my mixing 21.8 g of calcium silicate powder, 26.6 g of sodium silicate solution, and 4.5 g of deionized water. The mixing was done by high shear mixer (Speed mixer DAC 150.1 FVZ/Flack Tek Inc.).

The results of rheological measurements are summarized in Table 2. Viscosity increased with each measurement time interval. A stiff gel formed by day 20 making further viscosity measurements off-scale and impossible to collect.

### Example 1 (Ex.1)

A coating solution was made my mixing 42.8 g of zirconium silicate powder, 10.9 g of sodium silicate solution, and 13.5 g of deionized water. The mixing was done by high shear mixer (Speedmixer DAC 150.1 FVZ/Flack Tek Inc.).

The results of rheological measurements are summarized in Table 2. Viscosity was initially steady and decreased slightly with time. No gel was formed.

### Example 2 (Ex.2)

A coating solution was made my mixing 35.3 g of zirconium silicate powder, 26.6 g of sodium silicate solution, and 4.5 g of deionized water. The mixing was done by high shear mixer (Speedmixer DAC 150.1 FVZ/Flack Tek Inc.).

The results of rheological measurements are summarized in Table 2. Viscosity was initially steady and decreased slightly with time. No gel was formed.

### Comparative Example C (Comp Ex. C)

The coating solution of Comp Ex. B was applied to an aluminum plate and dried in ambient conditions (22° C. to 25° C.) for 24 hours, followed by 48 hours in an 85° C. drying oven. The final coating weight was approximately 1000 grams per square meter.

The coated and dried plate was exposed to the propane torch test and survived the full 10-minute test without any visible degradation to the aluminum substrate.

### Example 3 (Ex.3)

The coating solution of Ex. 2 was applied to an aluminum plate and dried in ambient conditions (22° C. to 25° C.) for 24 hours, followed by 48 hours in an 85° C. drying oven. The final coating weight was approximately 1000 grams.

The coated and dried plate was exposed to the propane torch test and survived the full 10-minute test without any visible degradation to the aluminum substrate.

### Comparative Example D (Comp Ex. D)

An uncoated, as-received aluminum plate. The uncoated plate was exposed to the propane torch test and melting was observed approximately 45 seconds into the test duration.

TABLE 2

| | | | | Example No. | | | |
|---|---|---|---|---|---|---|---|
| | | | | Comp | Comp | | |
| | | | | Ex. A | Ex. B | Ex. 1 | Ex. 2 |
| Weight of | | Calcium Silicate | | 26.4 | 21.6 | 0 | 0 |
| coating | | Zirconium Silicate | | 0 | 0 | 42.8 | 35.3 |
| solution | | Deionized Water | | 13.5 | 4.5 | 13.5 | 4.5 |
| components | | Sodium Silicate | | 10.9 | 26.6 | 10.9 | 26.6 |
| (g) | | | | | | | |
| Solid | | Calcium Silicate | | 84.9 | 65.5 | 0 | 0 |
| composition | | Zirconium Silicate | | 0 | 0 | 90.1 | 75.5 |
| coating | | Sodium Silicate | | 15.1 | 34.5 | 9.9 | 24.5 |
| (wt. %) | | | | | | | |
| Rheology | Day | 5 | RPM | 6200 | 9200 | 14900 | 47000 |
| (mPas) | 0 | 10 | RPM | 4200 | 6200 | 10100 | 30000 |
| | | 20 | RPM | 2700 | 4440 | 7320 | 15000 |
| | | 50 | RPM | 1460 | 2280 | 3340 | 5900 |
| | | 100 | RPM | 880 | 1480 | 1620 | 3100 |
| | Day | 5 | RPM | n/a | 25200 | 15000 | 40800 |
| | 2 | 10 | RPM | n/a | 13200 | 9900 | 2660 |
| | | 20 | RPM | n/a | 7230 | 7200 | 13680 |
| | | 50 | RPM | n/a | 3500 | 3560 | 5660 |
| | | 100 | RPM | n/a | 2160 | 1700 | 2600 |
| | Day | 5 | RPM | n/a | 60000 | 6000 | 21600 |
| | 6 | 10 | RPM | n/a | 24500 | 4000 | 10400 |
| | | 20 | RPM | n/a | 13080 | 2700 | 6360 |
| | | 50 | RPM | n/a | 9500 | 1540 | 3410 |
| | | 100 | RPM | n/a | 6680 | 840 | 2040 |
| | Day | 5 | RPM | n/a | n/a | 8800 | 24200 |
| | 20 | 10 | RPM | n/a | n/a | 5120 | 13660 |
| | | 20 | RPM | n/a | n/a | 3320 | 7360 |
| | | 50 | RPM | n/a | n/a | 1780 | 3900 |
| | | 100 | RPM | n/a | n/a | 960 | 2022 |

Thus, the present disclosure provides, among other things, coatings and article containing the coating that can be used in high temperature applications where impact resistance and/or thermal transfer resistance are desired. Various features and advantages of the present disclosure are set forth in the following claims.

1. A coating comprising:
zirconium silicate; and
an inorganic binder comprising an alkali silicate or a sol,
wherein the sol comprises a colloidal solid in a liquid, and
wherein the coating comprises 20 wt. %-95 wt. % zirconium silicate based upon the percentage of solids in the coating.

2. (canceled)

3. The coating of claim 1, wherein the alkali silicate comprises sodium silicate, potassium silicate, lithium silicate, or combinations thereof.

4. The coating of claim 1, wherein the alkali silicate is an alkali metasilicate having the formula M₂SiO₃, wherein M is Na, K or Li.

5. The coating of any claim 1, wherein the alkali silicate is a polysilicate having the formula M₂O(SiO₂)ₓ·yH₂O, wherein M is selected from Li, Na, or K, and x is between 1 and 15, and y is >0.

6. The coating of claim 1, where the coating comprises 5 wt. %-80 wt. % alkali silicate based upon the percentage of solids in the coating.

7. The coating of claim 1, wherein the sol comprises silica, titania, alumina, zirconia, or combinations thereof.

8. The coating of claim 1, wherein the size of the colloidal solid ranges from 3 nm to 60 nm in diameter.

9. The coating of claim 1, wherein the coating comprises 5 wt. % to 80 wt. % of colloidal solids based upon the percentage of solids in the coating.

10. The coating of claim 1, further comprising fibers.

11-16. (canceled)

17. An article comprising:
a substrate having a first major surface and a second major surface opposite the first major surface; and
a hardened coating of claim 1 on at least the first major surface of the substrate.

18. The article of claim 17, wherein the substrate comprises flame resistant paper, an inorganic fabric, flame resistant boards, thermoplastic resins, thermosetting resins, glass-fiber reinforced resins, metals, or combinations thereof.

19. The article of claim 17, wherein when the hardened coating comprises colloidal solid and the substrate comprises a porous material.

20. (canceled)

21. A method of making the article of claim 17, the method comprising:
mixing together the zirconium silicate and either a solution of the alkali silicate or a sol to form a coating solution;
applying the coating solution to at least the first major surface of the substrate; and
hardening the coating solution by drying and curing the coating solution.

22. The method of claim 21, further comprising mixing fibers together with the zirconium silicate and either the solution of alkali silicate or sol to form the coating solution.

23. (canceled)

24. The method of claim 21, wherein the coating solution exhibits a viscosity, and the viscosity does not increase by more than 5% over at least days 20 days.

25. The method of claim 21, wherein the coating solution is dried at a temperature of no more than 100° C.

26. The method of claim 21, wherein the coating solution is cured at a temperature of at least 100° C.

27. A battery comprising:
a plurality of battery cells separated from one another by a gap; and
the article of claim 17 disposed in the gap between the battery cells.

28. A battery comprising:
a compartment lid having an inner and outer major surface, the inner major surface covering a plurality of battery cells; and
the article of claim 17 disposed on the inner surface of the compartment lid.
